(19) United States
(12) Patent Application Publication
(10) Pub. No.: US 2003/0043016 A1
(43) Pub. Date: Mar. 6, 2003

(54) Locking device for electronic equipment

(76) Inventors: Darren J. Kady, Glenn Allen, VA (US); Deborah A. Kady, Glenn Allen, VA (US)

Correspondence Address: Parker & DeStefano, Suite 300, 300 Preston Avenue, Charlottesville, VA, 22902, US

(21) Appl. No.: 10/273,819

(22) Filed: Oct. 18, 2002

Related U.S. Application Data
(63) Continuation of application No. 09/178,837, filed on Oct. 26, 1998, now Pat. No. 6,469,615.

(51) Int. Cl. H04Q 1/00; G05B 19/00

(52) U.S. Cl. 340/5.1

(57) ABSTRACT

The operating control device can be use on electronic equipment, such as cell phones, computers, engine analyzers, etc. as well as non electronic equipment such as hand tools. An input device enables the input of user access data and a readout panel monitors the equipment status. A programmable feature selection member enables the user to select at least one programmable feature and respective activation time period. An internal member controls operation of the equipment by controlling power transfer from the power source to one or more said programmable features based upon user selection, to enable full or partial activation of the device.

### BACKGROUND OF THE INVENTION

1. Field of the Invention

The device relates to a safety and security device that, once activated, allows the electronic equipment to run for a preprogrammed period. In some embodiments, the device is used as an antitheft device as without the code use of the device is prohibited, preventing theft and resale of protected equipment.

2. Brief Description of the Prior Art

Electronic devices offer a temptation to thieves, as they are easy to resell due to lack of distinctive features. Although people will mark their electronic devices, such as cell phones, computers, etc., unless the stolen device is resold through a legitimate vendor, there is no hope for recovery.

### SUMMARY OF THE INVENTION

A locking device disclosed is for use on electronics, such as computers, cameras, cell phones, VCRs, DVDs, etc. and mechanical equipment, tools, heavy equipment and machinery, gas-powered vehicles, as well as various other wheeled vehicles. The device provides the option of permitting the equipment to be operarable or inoperable for a predetermined period of time, selection of specific operable features or being completely shut down with operation permitted only through code entry.

Electronic circuitry within the device, in conjunction with an unlocking and timer operation, requires that the equipment be unlocked prior to use. A time period for operation can be programmed into the equipment, after which time the unit shuts off or, conversely, the equipment can be shut down for a specific time period and automatically reactivitated. This reduces theft as well as preventing unauthorized use of the item.

The operating control device is for use with equipment having an exterior case, a power source, an input device, at least one activation member, and a control member. The control member, such as a separate chip or programming embedded into existing chips, either has it's own input device to enable the input of user access codes or uses an input device inherent in the equipment, such as the buttons on a cell phone. In the preferred embodiments, a readout panel is used to monitor the status of the equipment. The control member is in communication with the input device, readout panel, power source, and activation member. The control member prevents operation of the equipment by preventing the transfer of power from the power source to the activation member without the entry of a user code. Entry of the user code enables the power to flow from the power source to the activation member, thereby activating the device. The control member can also be programmed to control the internal functions of the electronic device, such as permitting the viewing of certain channels on a TV during a predetermined time, and other channels during other times. The device can also permit cell phone calls out, but not in, or vise versa, during set time periods. Any equipment having electronic components can be incorporated with the disclosed device to provide the ability to selectively determine which features are active for specific time periods.

The control device includes a programmable timer to communicate with the control member thereby enabling the power flow from the power source to the activation member for the predetermined period of time entered at the input device. A clock member, if not already inherent in the device, can be added to track time, activate, and deactivate the timer based on user input. In some embodiments the communication between the control member and the input device, readout panel, power source, driver member and activation member can be through electrical wires that can be encased in a solid material to make the control member and wires inaccessible. In the case of cellular phones, computers, cameras, etc., the need to access the interior would most likely prohibit the use of the solid packing material. The locking device can, as disclosed in co-pending application Ser. No. 09/178,837, be use on equipment such as hand tools, electronics or wheeled vehicles.

### BRIEF DESCRIPTION OF THE DRAWINGS

The advantages of the instant disclosure will become more apparent when read with the specification and the drawings, wherein:

FIG. 1 is a side view of an example hand tool incorporating the locking device;

FIG. 2 is a cutaway view of the interior of the locking arm and solenoid of the instant invention;

FIG. 3 is a top view of an example controller configuration;

FIG. 4 is the schematic of an example wiring for the locking device for use with a hand tool;

FIG. 5 is a cutaway side view of the interior of the hand tool of FIG. 1;

FIG. 6 is a cutaway side view of an alternate embodiment of a hand tool utilizing the disclosed locking device;

FIG. 7 is a side view of the instant device for use with a air tool system;

FIG. 8 is a schematic of the wiring for use with the locking device used in conjunction with air tools;

FIG. 9 is a cutaway rear view of the mechanically activated bicycle locking device;

FIG. 10 is a side view of the bicycle locking device of FIG. 9 mounted in a bicycle;

FIG. 11 is a top view of the engagement disk for use with the bicycle locking device;

FIG. 12 is a side view of the bicycle locking device of FIG. 11 mounted in a bicycle;

FIG. 13 is a cutaway view of the solenoid activated bicycle locking device mounted on a bicycle;

FIG. 14 is an exploded view of the engagement disk and latching solenoid;

FIG. 15 is a schematic of the wiring for use with electronic devices;

FIG. 16 is a schematic of the wiring for use with the locking device incorporating the analogue function;

FIG. 17 is a schematic of the wiring for use with the locking device on mechanical apparatus, such as bicycles;

FIG. 18 is a flow chart for programming a dual operation device; and

FIG. 19 is a flow chart for programming a single operation device.

### DETAILED DESCRIPTION OF THE INVENTION

The disclosed invention relates to a programmable device having multiple programmable features including, but not limited to, restricting accessibility to specific portions of a device and coded locking mechanism that discourages theft and restricts or eliminates use during a predetermined time frame. In addition to the inherent advantages obtained through the locking device as disclosed, further safety advantages are achieved simply by its existence. It will be obvious to anyone who buys an item containing the locking device that unless the seller has the code, the item is most likely stolen. Most theft of portable items, such as tools, bicycles and electronic equipment such as cameras, cell phones, palm pilots, is related to resale of the item. Generally, this resale is through pawnshops, or individuals, who have no way of tracing ownership of the item. The disclosed locking device controls the activation of the item, preventing activation without the entry of user codes. Without access to the codes, the item is useless and unsaleable. Additionally, any business receiving an stole item for sale whose seller cannot provide the codes, immediately knows it is stolen property and can report the theft.

Electronic devices, such as cell phones, palm pilots and other hand held data access devices, cameras, computers, VCRs, televisions, MP3 players, etc. all are easy theft devices with high resale value. Their use of programmable chips, however, makes these valuable devices easy to modified to incorporate the advantages of the disclosed system. Alternatively, in some device such as computers, VCRs and televisions, the device can be retrofitted into the power source, such as the power cord or plug. The use of microchips, or analog, technology, however, permits various functions to be monitored, such as scheduling service, based on use time or the number of hours an item has been used.

Bicycles have been, to date, difficult to protect against theft. The standard means for securing a bicycle is to chain the frame to a non-movable object. The thief, however, can simply cut the chain and ride the bike away. The disclosed device locks the pedals, thereby preventing the bike from being ridden and requiring a thief to pick the bicycle up and carry it off. The addition of an alarm will further deter the theft of the bike. Except in secluded areas, this would cause far more attention than most thieves are willing to risk. The incorporation of the disclosed device installed on a bicycle is discussed in detail further herein.

The locking mechanism is preferably of a type that does not require the use of a key, or other device, thereby avoiding an additional item to lose or carry. Access through keypads or other locking means can be used, such as magnetic card readers, fingerprint or retinal recognition, standard keys, telephone signals, or any applicable wireless technology, etc. The method of programming the device is dependent upon the type of device, size, etc. The touch key scanning, or any other method of transmission having static data, can easily be incorporated into the device, thereby permitting data relating to the item to be tracked. The disclosed technology provides benefits in a laboratory or other setting where equipment is centralized and removed for use. Each employee would have a personalized touch key, or other wireless or non-wireless access means, that would record the employee name, time of activation, and any other information required by the employer. In instances where security or training levels are required to use a device, the personalized access device can also carry the ID code enabling use of the device, thus preventing use by unauthorized personnel. Devices containing static data, such as a touch key, provides the advantage that an employer, or parent, can program the touch key with the pertinent data, including activation time, and that data cannot be changed except by someone with top level programming rights. This is advantageous when using equipment that must be shut down after a specific period of use as the preprogrammed time relieves the user from the responsibility of watching a clock. Although shut down could also be obtained through other methods, the disclosed system provides the additional advantages as set forth herein, thereby consolidating systems.

When installed on computer, the disclosed device can be connected directly to the power supply or programmed into the chip; permitting businesses that sell computer time to automatically shut down the computer unless additional time is purchased. In home use, the device permits parental control on the amount of time, or specific time periods, the computer, or other electronic device such as a TV, can be used by a child. Thus, the computer, VCR or TV could only be activated after homework is completed, etc. Computers are especially adaptable to keyboard programming of the device, although a keyboard interface can be included with any of the locking devices disclosed. A program embedded in the device's microchip can allow for a simple timer setting that is activated through key input on the keyboard. As an option, a direct coding key can be incorporated on the keyboard that automatically accesses the program and permits activation, setting changes, etc. Although computer lock out programs are known in the prior art, they totally lock out use of the computer in an all or nothing method. The disclosed device permits access to the computer for a predetermined period of time either at random or within a specific schedule time, optionally, to extend the amount of time to use the device without interruption. The user entering the time restraints would set up the program with a user code to prevent unauthorized changes to the program.

One of the programmable features disclosed herein is a partial activation feature, as described in detail hereinafter with relationship to cell phones. Using this feature, the user can restrict partial use of the electronic equipment, for example a computer can be programmed to restrict certain programs, such as web access, during specific time periods. For example, children could be prevented from surfing the web except during specific time periods. Or computer games could only be accessed for a restricted time, however the computer could be used for word processing or other homework related activities. This feature enables the computer to be used, but in a restricted manner, based upon user programming.

The disclosed locking device is also advantageous for rental equipment, such as generators, compressors, VCR's, etc., in that the rented equipment can be programmed for a specific period of time and after that point be automatically deactivated. This discourages the theft of rental equipment, thereby reducing insurance and liability, since by preventing unauthorized use, especially when used in conjunction with larger equipment, insurance rates would potentially be reduced.

In electronic equipment, such as TVs, VCRs, etc. containing infrared remote controllers, the timing activation device can be activated through the remote controller. Once activated the program would appear on the screen and utilize either existing or specific keys to set the shut down time, user time periods, or extend the time period, etc. This would be an inexpensive addition to a controller and increase user convenience. Alternatively, the controller itself can be used to set the time of use, without the appearance of the setting program on the screen.

It should be noted that the use of analogue, key scanners, infrared, fingerprint or retinal recognition, etc. taught herein for use by a specific embodiment, is not limited to that embodiment. Each embodiment of the locking device disclosed herein can incorporate the electronics, memory, etc. as described herein in relation to any other embodiment.

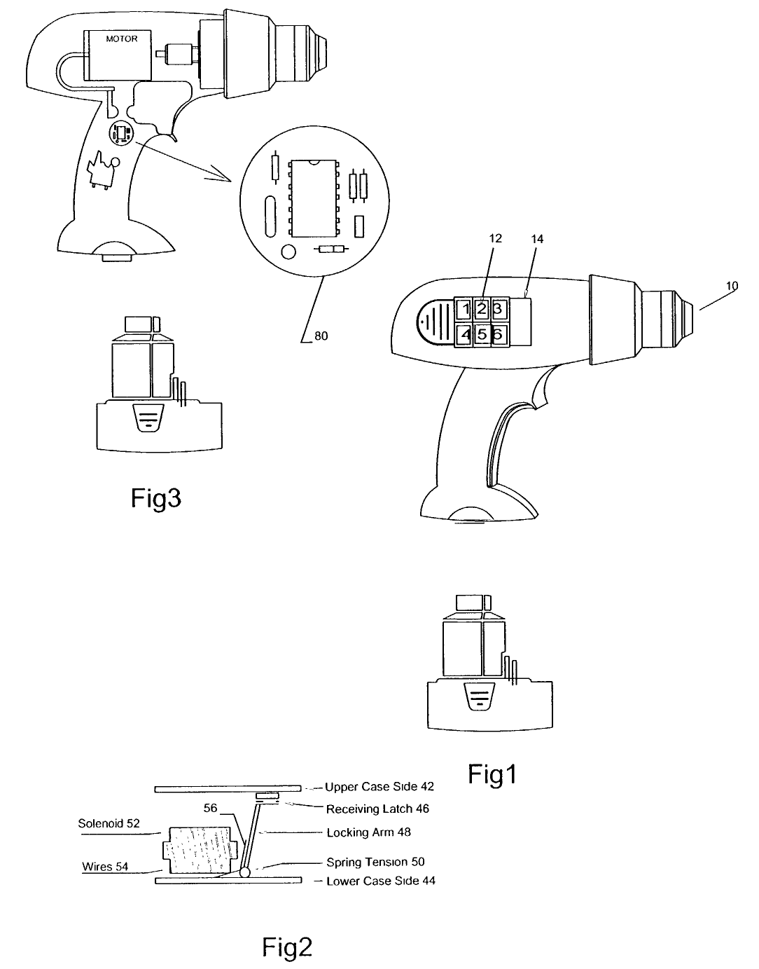

A hand drill, as illustrated in FIGS. 1 and 2, is used to illustrate the disclosed mechanism used to limit user time, however this is as an example only and is not intended to limit the invention. In order to facilitate the description of the embodiments herein, the recipient of the power received will be referred to herein as the driver. The power tool 10 is illustrated in FIG. 1 ready for use, incorporating a numeric keypad 12 as the locking mechanism. Other activating mechanisms will be apparent to those skilled in the art when read in conjunction with the disclosure. As stated heretofore, in many applications advantages are provided by not having an additional device to activate the tool. However, in some residential and commercial applications, the separate activation device can be desirable. It is preferable when using this embodiment to protect devices owned by the user, that the use be on a timed basis rather than an on-off basis. Forgetting to the turn off access to the device would negate the advantages to the disclosed locking device.

The time can be set through any means appropriate to the equipment being used as well as the final use. For example, the time can be through repeatedly touching a specific key, jumping the time by predetermined increments. Alternatively, an “enter” key can be provided which allows entry of the unlocking code and subsequent entry of a predetermined period of time. Preferably, all timed locking devices are provided with nonvolatile memory to prevent the loss of programmed instructions in the event the item's battery goes dead or is removed. This is more critical with rechargeable hand tools where completely discharging the battery is sometimes required to fully recharge. On larger items, such as construction equipment or generators, a cellular dial in can be included to allow the addition of time to be accomplished remotely from the owner's location. A microphone can be added to the locking device to receive, and register, a code consisting of telephone touch-tones to extend the operation time. Various other methods can also be used, and these methods will be evident to those skilled in the art.

The locking code can be factory set and the code numbers provided at time of purchase. Alternatively, the locking code can be reprogrammable either by the user or by a factory representative. The reprogrammable feature enables the code to be changed when required, such as sale of the tool. The device can be capable of being reprogrammed more than one time, however, the number of reprogrammings allowed, and the party performing the reprogramming, all affects the security of the device. For maximum security, while still allowing reprogramming, the device is provided with only one or two opportunities to reprogram the code and the reprogramming would be completed at a service center. In the optimum configuration, other readings are also provided that would be critical to the operation of the device. The incorporation of a microchip to register the locking codes and program the activation time further provides the added ability to monitor various other tool functions. For example, an LED display 14 of FIG. 1 can be included which indicates the activation time remaining and, if desired, the current status of the tool. The status can include, for example, current battery power (both during recharge and discharge), pressure remaining when air tools are used, rpm and direction of drills, etc. This is of optimum use in monitoring the status of rechargeable batteries. Since many rechargeable batteries do not either fully charge unless fully discharged prior to recharging, the battery-monitoring device permits optimum use and management of the battery. It should also be noted that an LED could be provided on the recharging device to monitor the battery recharge thereby serving as a double check to the LED on the device being charged.

Although the optimal time to incorporate the disclosed system is at manufacture, in many embodiments the system can be retrofitted to incorporate the features in an existing device. The method is dependent upon the device however, in many instances, the addition or replacement of a board would enable all or most of the features disclosed herein to be incorporated into the existing device.

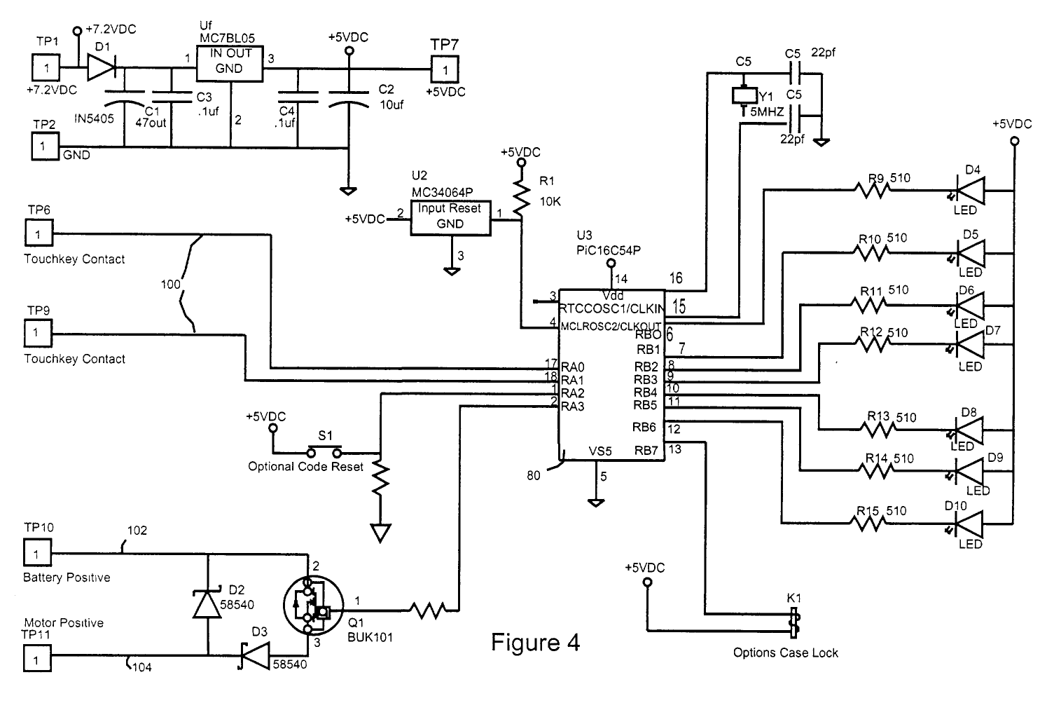

In FIG. 2, one design of the internal activation unit 40 is illustrated. The locking arm 48 is supported between the upper case side 42 and the lower case side 44. The spring tension 50 is designed to place the solenoid contact 56 in physical contact with the solenoid 52 when the locking arm 48 is pulled back during use. Once the locking arm 48 is released, the solenoid contact 56 is removed from contact with the solenoid 52. The solenoid 52 receives power from the battery 108 (FIG. 5) through the controller 80, an example of which is illustrated in more detail in FIG. 3. As can be seen from the example schematic of FIG. 4, the controller 80 serves as the central processing area, with all input and output passing through the controller 80. The controller 80 is connected directly to the locking mechanism, such as a numeric keypad 12, through the keypad wiring 100. The battery wiring 102 and motor wiring 104 also feed into the controller 80. Once the locking means, such as numeric keypad 12, is activated, all connections are made and power is free to go to the driver specific to the power tool 10. The exact schematic of the wiring is not critical, as the criticality lies with in the interaction between the locking means and the controller 80. The interior of the hand tool 10, as shown in FIG. 5, is traditionally spaced, with the controller 80 located within the handle area. In this embodiment, the various connecting wires 100, 102 and 104 are exposed and, in the event of theft, the case can be opened and the wires cut and crossed to bypass the controller 80. In order to prevent a thief from opening the case and by passing the controller 80, the case is provided with a safety lock key having a number of different embodiments. One embodiment is to incorporate a locking member, wired to the control through the locking wire 156, that is deactivated by a locking code, key or other compatible methods. The controller 80 can be programmed to allow the case to release, for example through a separate code being entered or by holding down the last number of the existing code for a predetermined time period. A separate code is preferable in that it prevents any unauthorized access to the interior of the case. For maximum security, the safety lock key would be available only to certified dealers and service companies for the specific brand or obtained directly from the dealer by mail, etc. By providing the safety lock key, if the tool was stolen and tampered with for sale or pawn, the by-pass would be apparent due to the broken casing.

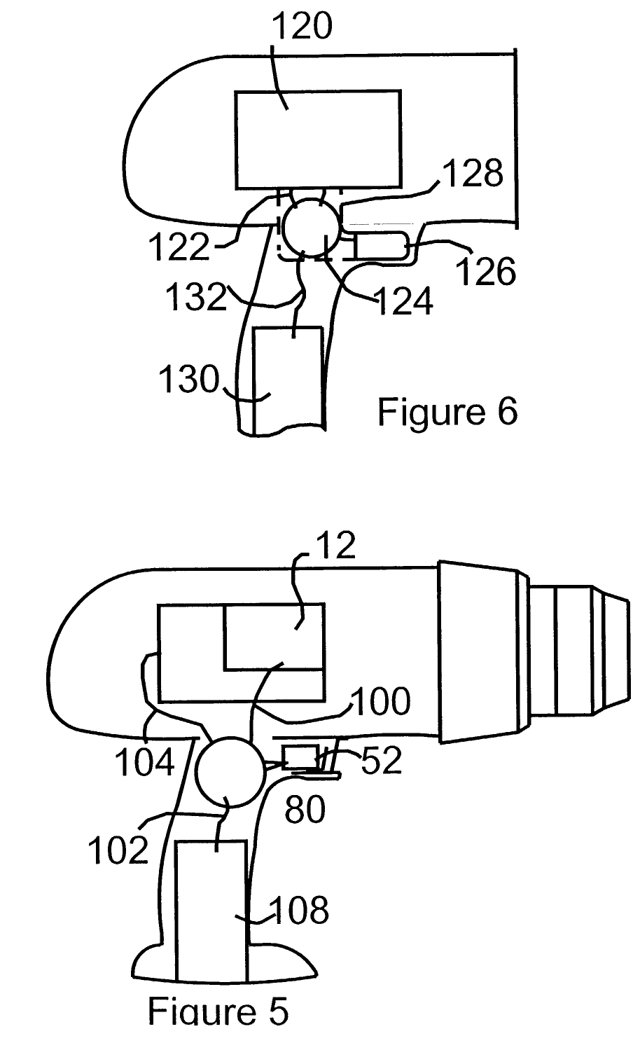

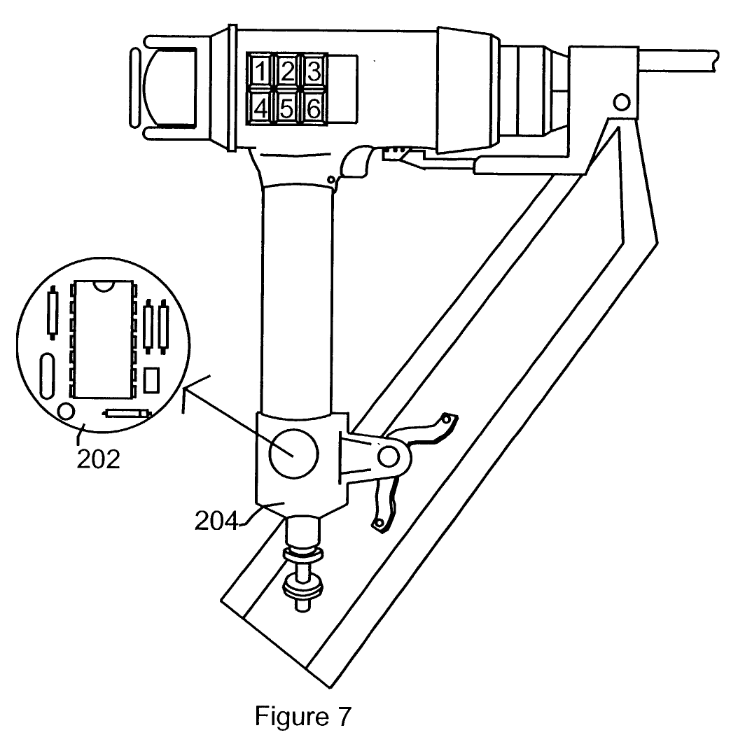

In an alternative embodiment to the safety lock key, the solenoid 126 and wiring 122 are encased in an epoxy, indicated herein as region 128, as illustrated in FIG. 6. By encasing the wiring 122 within the epoxy, it is impossible to rewire the unit and bypass the controller 124. Other materials, known in the art, can be used to replace the epoxy. To facilitate the placement of the epoxy region 128, the wiring 122 from the motor 120 exits the motor casing proximate the controller 124, which has been placed as close as possible to the solenoid 126. This revised placement reduces the area to be protected, thereby reducing material and labor costs. Revising the placement of the battery 130 is difficult, preventing in some instances the battery wiring 132 from being covered. However, with the controller 124 and solenoid 126 both encased in epoxy, there would be no value to cutting the battery wire 132, as there would not be any accessible power connections.

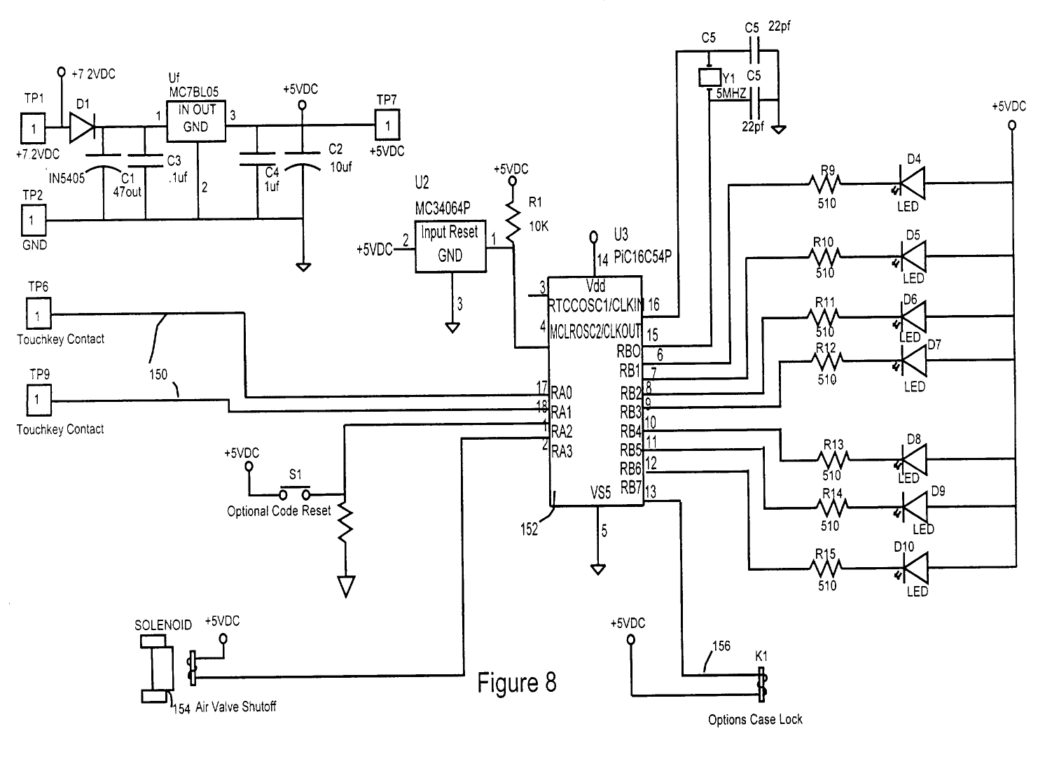

In FIG. 7, the locking device is illustrated being used with an air tool 200, although it should be noted that the device can also be used with propane, gas, and diesel tools and equipment. This embodiment is additionally applicable for use with electric tools and equipment having a power cord. The controller unit 202, as illustrated, is located in the handle 204 of the air tool. Due to the spread out nature of the air tools, the use of a safety key lock is, in some instances, more practical than redesigning the interior of the unit to allow the wiring to be embedded in epoxy. This is a choice of the manufacturer based on cost, specific tool, etc. As can be seen in the example schematics of FIG. 4 (battery) and FIG. 8 (air tool) there is little difference in wiring between the two. As stated, in the schematic of FIG. 4 the touch key-wiring 100 goes to the controller 80, as does the battery wire 102 and the motor wire 104. In the air tool, or other removed power source, the touch key wiring 150 and solenoid 154 wiring feed into the controller 152 and onto the driver, the battery and motor connections being eliminated.

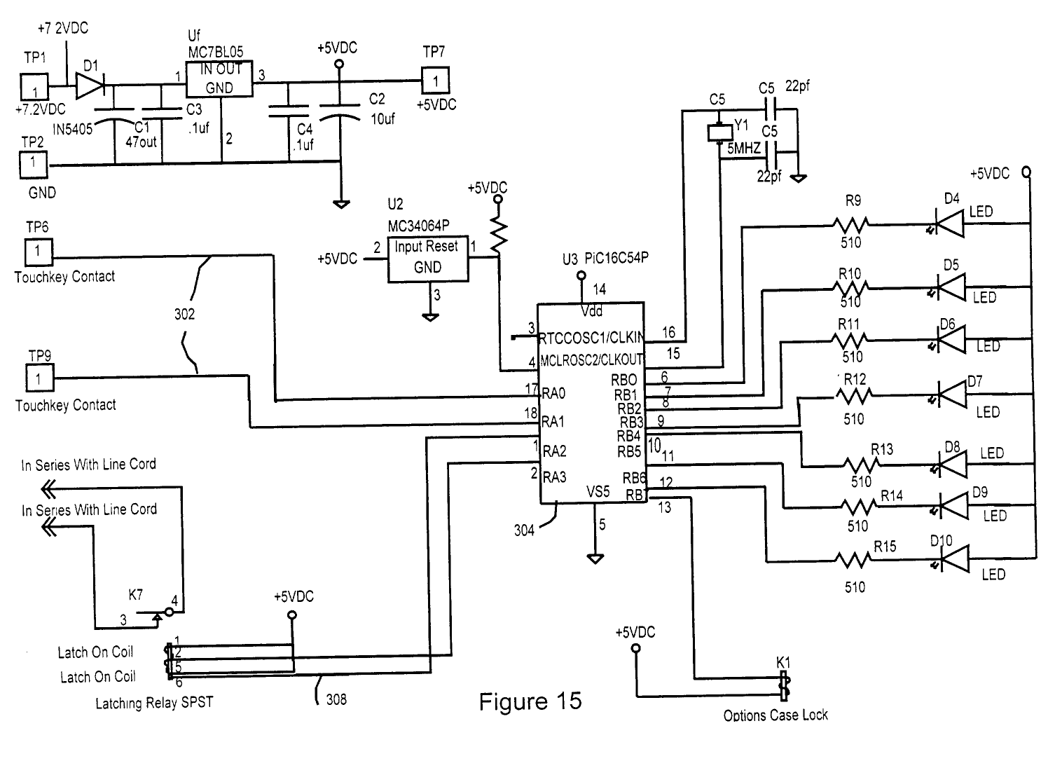

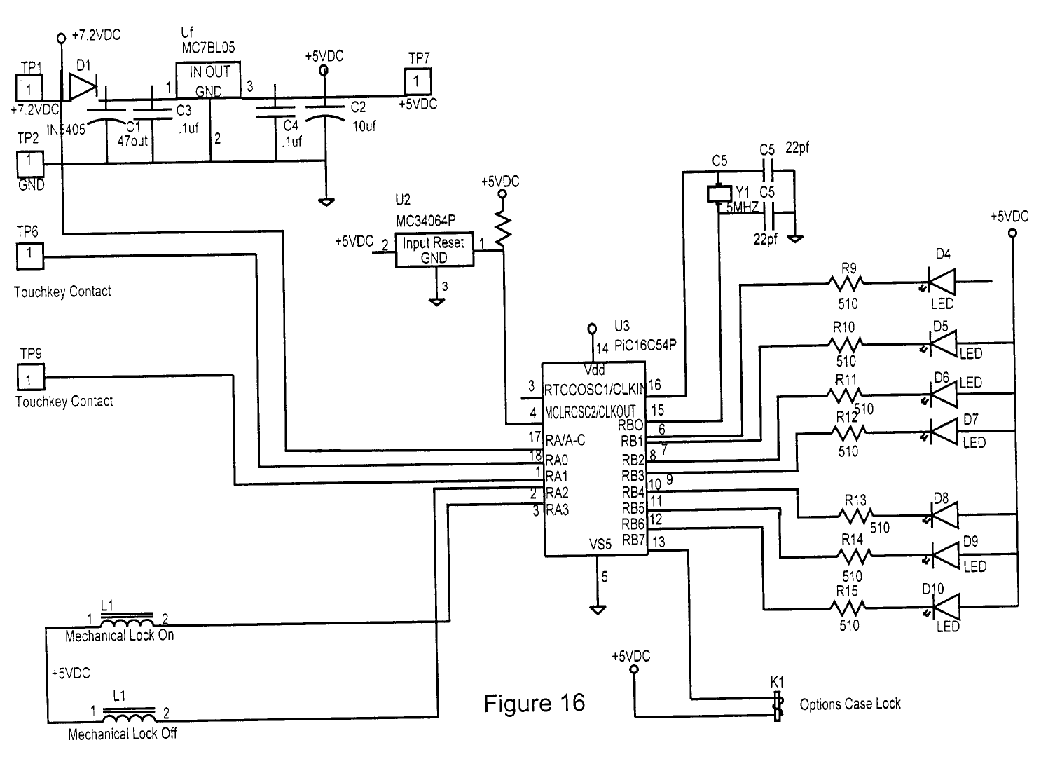

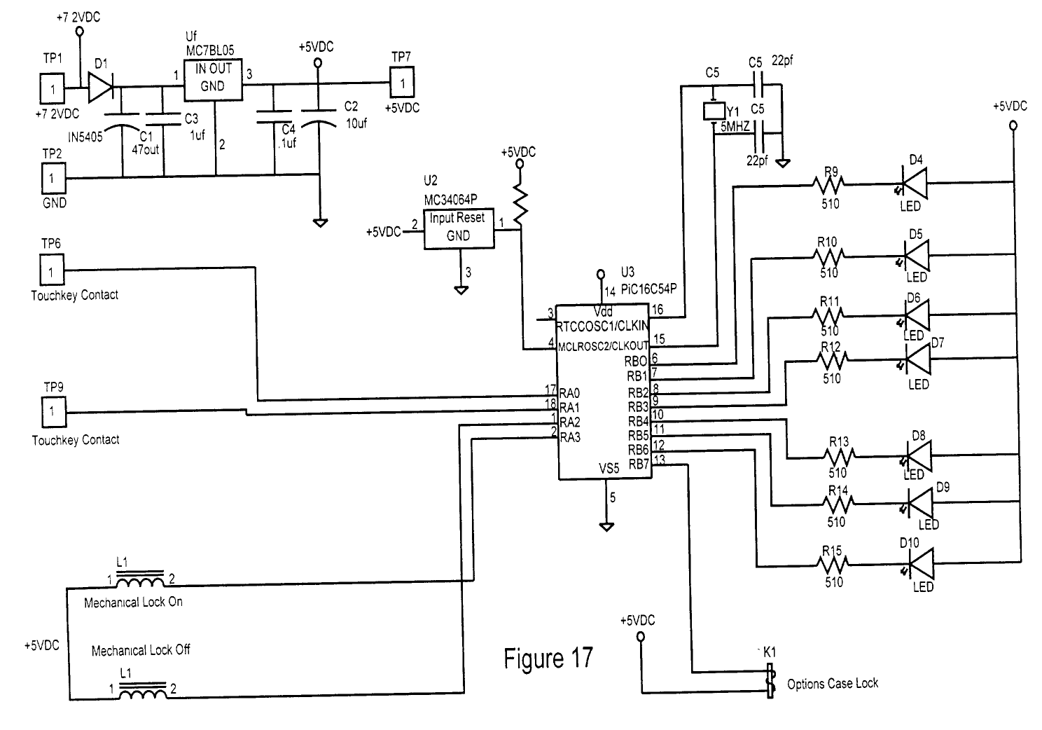

As stated heretofore, the disclosed device can be easily incorporated with electronic equipment. The schematic of FIG. 15 is an example of the electronics for a device being incorporated into a computer, VCR, television, etc. As can be seen, the basic functioning of the antitheft device is the same as used for a battery or air tool. As in the schematics disclosed heretofore, the touch key wiring 302 feeds into the controller 304. In this embodiment, however, the electric wiring 306 is connected to the controller 304 through the latching relay wires 308. The schematic of FIG. 16 provides an example of the electronic layout, disclosed in FIG. 15, to incorporate the analogue function into the device through analog wiring 350.

Cellular phones are a small sized, high dollar theft item that is difficult to protect. Most people leave their phones on all of the time so the implementation of an on/off-activated lock would not prevent theft as the phone would most likely be turned on when stolen and a thief would simply leave the phone on. Incorporating the disclosed system, the thief would know that there was no way to stop the phone from shutting down and that once the time had expired the phone would be unusable. Using the disclosed system, the user could program the phone to shut off permanently at the expiration of a predetermined time or, alternatively at a preset time. This would enable the user to tell the system that it should shut off at, for example 9:00 p.m., or alternatively once the timer reach three hours from the programming time. The discloses system further enables a user to set the phone to be shut down for a predetermined period of time, with automatic reactivation at the end of the time period. The ability to turn the phone off for a predetermined period of time, after which it reactivates, is beneficial for people attending meetings, movies, or some other activity that requires the phone to be turned off. Since the phone will automatically reactivate, the user does not need to worry about turning the phone back on. In the preferred embodiment, the phone can also be set to either receive calls or make calls, as well as the standard incoming/outgoing feature. Thus, if the phone is being loaned out and the owner of the phone does not want his/her calls to be picked up by anyone else, the phone can be set to forward all of the phone owner's incoming calls to their voice mail or other call forwarded location, while still allowing the person having the phone to make outbound calls. In the reverse mode, the person having the phone can receive calls, but cannot use the phone to call out.

A delayed activation can also be programmed into any of the devices to enable the device to be activated at a specific time or after a certain amount of time has lapsed. Thus in applications such as the electric tools used on a construction site, the foreman can program the tool to activate in thirty minutes and to stay activated for an additional eight hours.

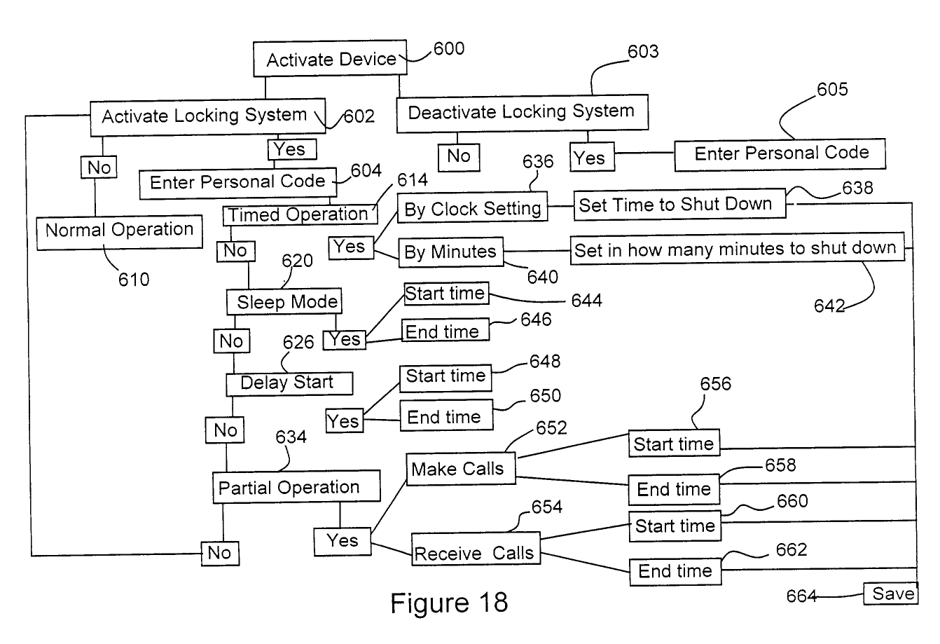

A sample of a sequence for the user to follow when programming a cell phone is illustrated in FIG. 18. Once the device is activated 600 the system inquires whether the user would like to activate the locking system 602 or, if already activated, deactivate the system 701.

### Deactivation

If the user chooses to deactivate the system 603 or 701, they simply enter the personal code 605 or 703 and the system returns to standard operation. If, however, the user has either changed their mind or made the incorrect selection, they indicate “no” and the programmed features remain as currently set.

### Activation

If user answers “no” to the activate locking system 602, the system, as illustrated in FIG. 18, proceeds to normal operation 610. If, however, the user answers “yes”, the system requests the personal code be entered 604. The user is then presented with several modes from which to select. These modes can be viewed by scrolling or, depending upon the size of the screen, all displayed with the arrow keys enabling selection. It should be noted that the sequence discussed herein in respect to this Figure is not intended to limit the invention in any way and different sequencing, alternative actions, etc. can be incorporated.

The Timed Operation mode 614, provides the user the ability to shut down the operation of the device by clock setting 636 or number of minutes 640. In the event the clock setting 636 is selected, the user then enters the time of day that the device shuts down 638. If the minutes 640 module is selected, the number of prior to shutting down is requested 642. The selection of “no” as a response brings up the sleep mode 620 operation which, if entered through, enables the user to set a start time 644 and an end time 646 during which the device is inoperable. “No” again bypasses the sleep mode 620 to the delay start 626 mode which enables the user to set the commencement of the start time 648 at a time later than the time of entry. The end time 650 is similar to the sleep mode end time 646. The partial operation mode 634 enables the user to device the ability to make calls 652 from the ability to receive calls 654. When the make calls 652 operation is selected, the user enters the start time 656 and the end time 658 during which calls can be made. The receive calls 654 also permits start time 660 and end time 662 entry. In the event the user selects none of the modules the system returns to the activate locking system mode 604.

Depending upon the end cost, the device can be programmed to accept multiple different commands, such as a sleep mode 620 where it does not operate from the start time 644 to the end time 646 and timed operation 614 in which the device shuts down 638 at 8:00 pm.

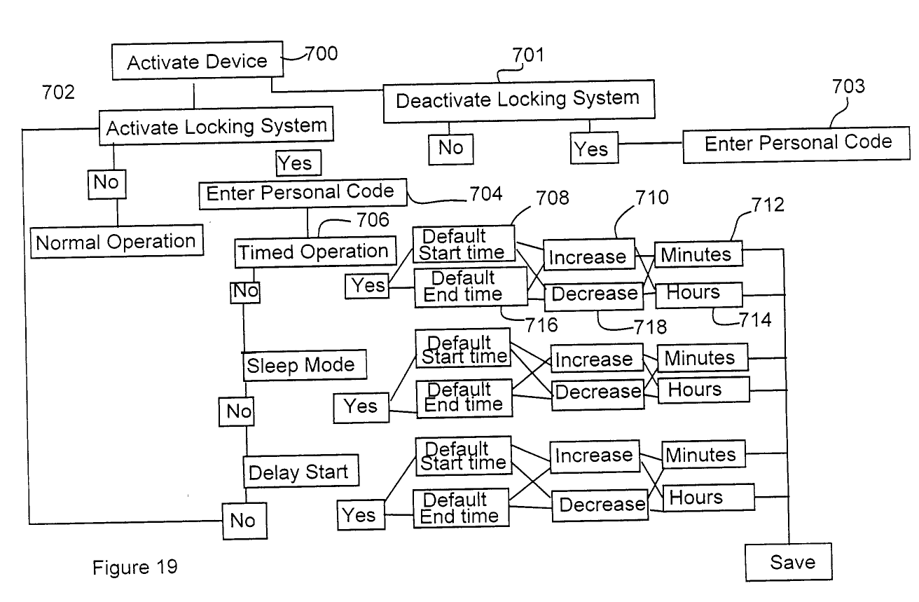

In FIG. 19, rather than enter a specific start time, as set forth in the prior Figure, a default time has been entered. Therefore, once the user activates the device 700, responds positively to activating the locking system 702 and enters the personal code 704. Upon selection of the timed operation mode 706, the default start time 708 is displayed, giving the user the opportunity to increase 710 or decrease 718 the time by either minutes 712 or hours 714. The default end time 716 is adjusted in the same fashion. Each of the modes in this Figure provide the default time options, however it should be noted that the default modes illustrated in FIG. 19 can be also included in conjunction with the timer setting modes illustrated in FIG. 18. Alternatively the user can be provided with the choice of whether to select the default or the timer settings.

FIG. 19 would be more applicable for cameras, TVs and other devices that have only one type of operation. In other words do not have the dual operations, send and receive, as does a cell phone or a VCRs record and play. It should be noted that the system as disclosed in FIG. 19 is deactivated in the same way as explained in FIG. 18.

One use of the disclosed invention is in commercial industries with workers using company owned tools and equipment. The tools are activated in the morning to run for an entire shift, at which point they shut down. This prevents theft from outside sources as well as employees. Additionally by reactivating the tools each morning, a “safety check” can be incorporated with the activation to prevent faulty equipment from being used.

The locking device can further be used with bicycles, shopping carts, wheelchairs, etc. It should be noted, however, that since the locking devices disclosed herein operate on bicycles by stopping movement of the pedals, this device is not recommended for bikes, or other items that have foot brakes. In the event, that the device was activated during use, the user would be unable to activate the brakes. The example used herein is a bicycle, however the device, as disclosed, can easily be adapted for a variety of other wheeled devices. The locking device for use with bicycles, or other applicable devices, preferably has a weight of about one (1) pound or less.

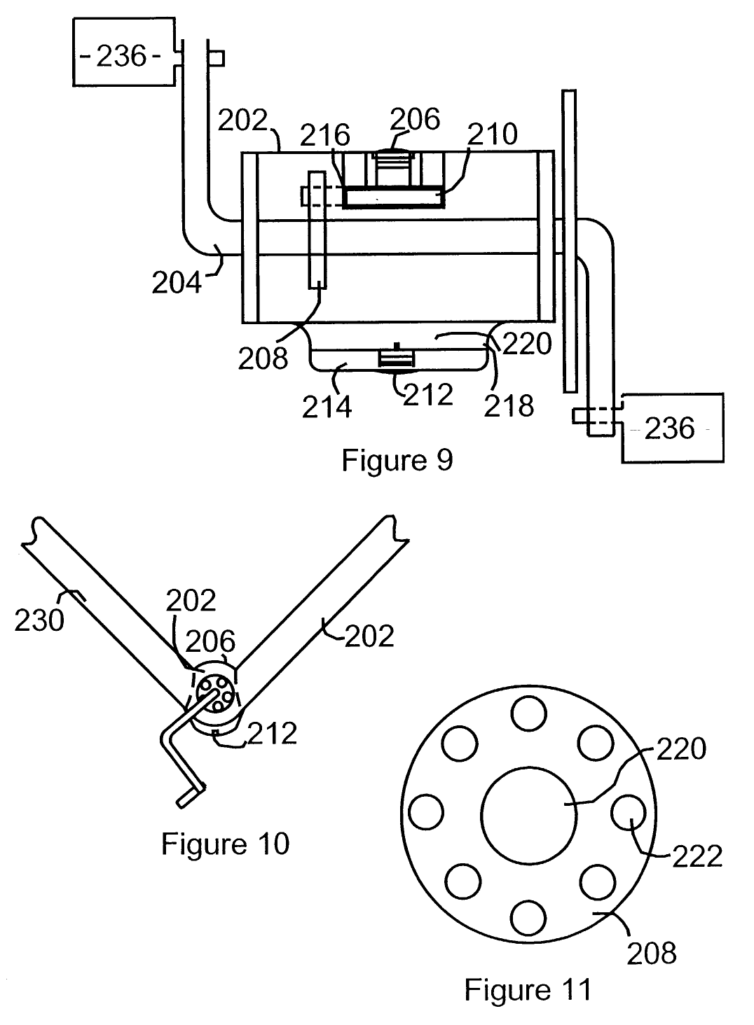

FIGS. 9, 10 and 11 illustrate a manual version of the locking device 200 for use with wheeled vehicles and is illustrated on a bicycle. The locking mechanisms within the locking device are located within a protective case 202 to prevent tampering. The case 202 is welded to the front frame 230 and rear frame 232 as currently done in the art replacing the standard joint at the juncture of the front and rear supports. The case 202 is slightly larger than standard cases to accommodate the locking device 200. The pedal axle 204 passes through the case 202 and is attached to the pedals 236 as known in the art. The engagement disk 208 has a centered receiving hole 220 that permits the disk 208 to be mounted on the axle 204. The disk 208 is welded to the axle 204 to cause the disk 208 to rotate with the axle 204 as the bicycle is pedaled. The disk 208 contains a series of receiving holes 222 around its periphery. The receiving holes 222 are dimensioned to receive the locking bar 210 that has been encased in the locking brace 216. The locking brace 216 is secured to the case 202 to prevent movement of the bar 210 and therefore movement of the pedals 236 once the bar 210 is in the locked position. When in the unlocked position, the locking bar 210 is drawn into the locking brace 216. Once placed into the locked position, the bar 210 engages the receiving holes 222 of the disk 208 and prevents the pedals 236 from turning. The locking brace 216 must be securely affixed to the case 202 to prevent the brace 216 from dislodging when a user attempts to pedal during the locked mode. Additionally, the locking bar 210 must have sufficient strength to prevent the bar 210 from snapping or bending. In the embodiment of FIG. 9 the bar 210 is placed into either the locked or unlocked position by a key lock 206, or other mechanically operated device. The interior mechanisms moving the locking bar 210 in response to the key lock 206 are like those of dead bolts for doors and other methods will be known to those skilled in the art.

To provide the ability to repair the locking device in the event a problem arises; a bottom plate 214 is incorporated into the locking device 200. The bottom plate 214 illustrated has a rotating lock 212 that is secured to a locking plate 220. The flanges 218 extend into the open area of the case 202 and provide support for the locking plate 220 when rotated to the locked position. Rotation of the rotating lock 212 moves the locking plate 220 into a position to clear the flanges, thereby permitting removal of the bottom plate 214. The locking mechanism for the bottom plate is an example of a method for locking the bottom plate onto the case and other methods known in the art can be used.

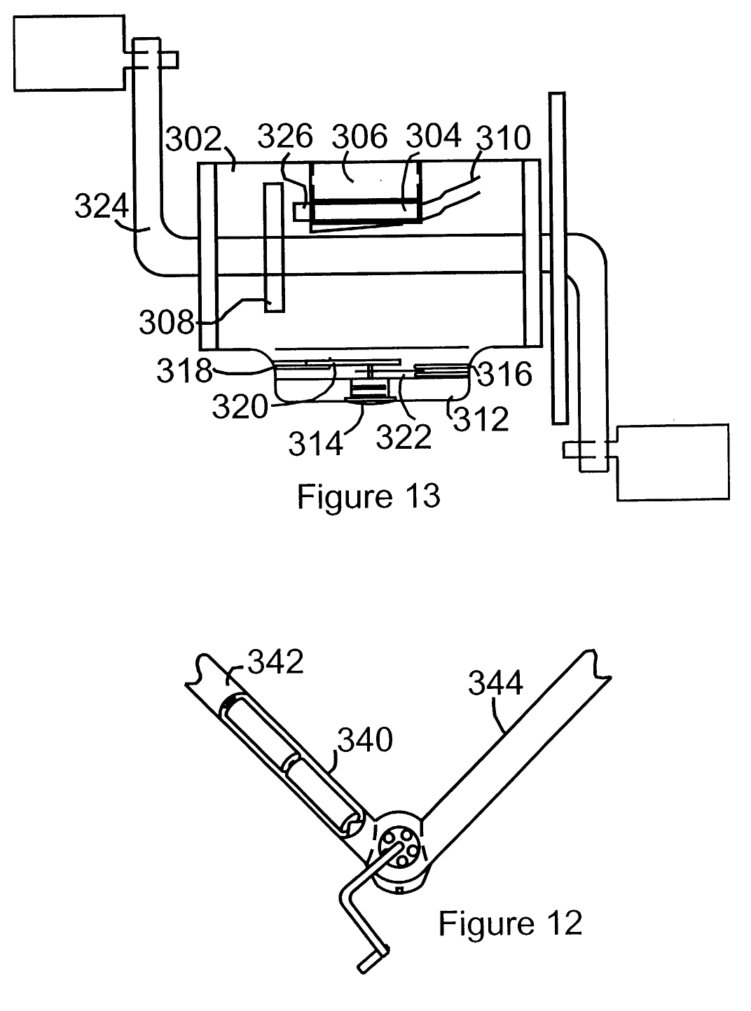

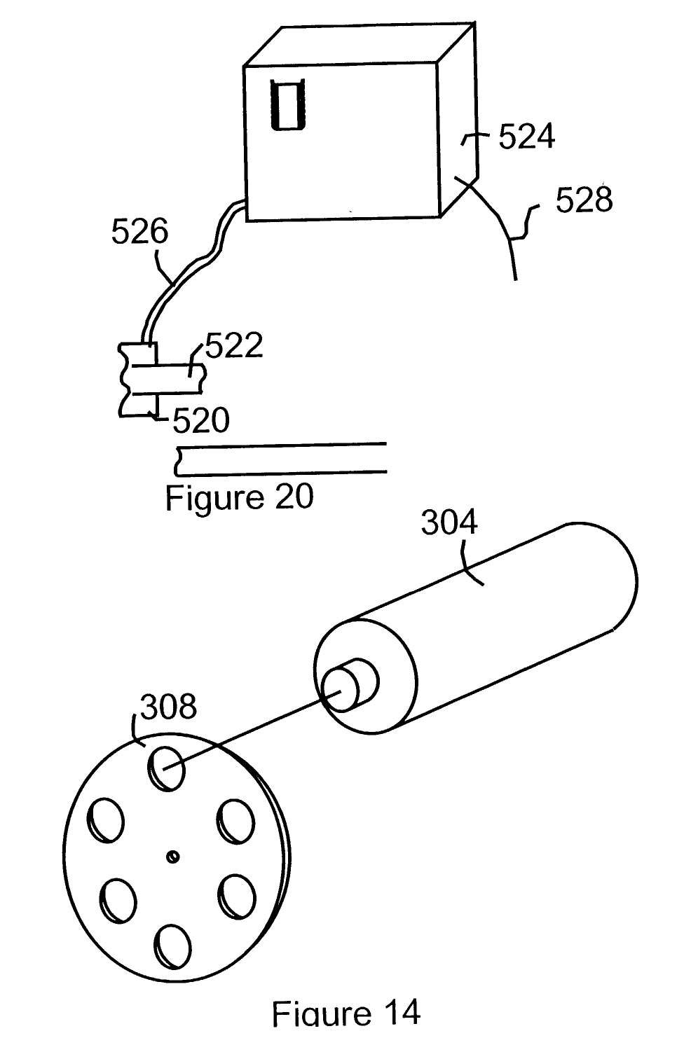

An automatic embodiment of the locking mechanism for use with bicycles is illustrated in FIGS. 12-14. The engagement disk 308 is welded to the pedal axle 324 as described heretofore. Rather than the manual lock of FIG. 9, the interacting locking bar 326 is operated by a battery-powered solenoid 304. The solenoid 304 is maintained in position through use of a casing 306 that is securely affixed to the outer case 302. As stated heretofore, the locking bar 326 must be capable of withstanding the pressure exerted by a person attempting to pedal the bike. The batteries 340 to power the solenoid 304 can be contained within the front support 342 or other location convenient for manufacture. The use of a battery-powered solenoid also permits the use of a timer as disclosed for use with the hand tool of FIG. 1. The analogue timer is advantageous for companies renting bikes by the hour or day as the timer can be activated upon the bike being removed from the shop and the time read and calculated upon return. The timer readout, entry method, etc., can be incorporated in either the front support 342 or back support 344.

The base plate 312 uses an alternate design to the embodiment of FIG. 9. In this embodiment, the base plate 312 is provided with a key lock 314 that is attached to dual rotating bars 320 and 322. The sides of the case 302 are provided with flange pairs 318 and 316 that are dimensioned to interact with the rotating bars 320 and 322. Thus, as the key lock 314 is turned, the bars 320 and 322 move out of their interaction with the flange pairs 318 and 316, thereby releasing the base plate 312.

Since other modifications and changes varied to fit particular operating requirements and environments will be apparent to those skilled in the art, the invention is not considered limited to the example chosen for the purposes of disclosure, and covers all changes and modifications that do not constitute departures from the true spirit and scope of this invention.

What is claimed is:

1. An operating control device for equipment having an exterior case, a power source, an internal feature activation member, said control device having:
a predetermined user access code,
a programmable feature selection member, said programmable feature selection member enables at least one programmable feature to be selected by said user,
at least one programmable feature activation time period, said programmable feature activation time period being set by a user for each of said at least one programmable feature,
an input device, said input device permitting input of said predetermined user access code, said programmable feature selection and said programmable feature activation time period;
a readout panel, said readout panel providing a status of said operating control device;
an internal control member, said control member being in direct communication with said input device, said power source, said programmable feature activation time period and said programmable feature activation member,
wherein said internal control member controls operation of said equipment by controlling power transfer from said power source to one or more said programmable features based upon user selection of said programmable feature and said programmable feature activation time.

2. The control device of claim 1 wherein said equipment is a cell phone.

3. The control device of claim 2 wherein said programmable features include at least one from the list of normal operation, timed operation, sleep mode, delayed start, partial operation.

4. The control device of claim 3 wherein said partial operation includes making outbound calls and blocking inbound calls for a preprogrammed time period.

5. The control device of claim 3 wherein said partial operation includes receiving inbound calls and blocking outbound calls for a preprogrammed time period.

6. The control device of claim 1 wherein said equipment is a TV.

7. The control device of claim 6 wherein one of said at least one programmable feature is station selection and one of said at least one programmable feature activation time period is the time said station selection can be viewed.

8. The control device of claim 1 wherein said equipment is a computer.

9. The control device of claim 8 wherein one of said at least one programmable feature is program selection and one of said at least one programmable feature activation time period is the time said program selection can be activated.

10. A method of controlling the use of electronic equipment using a locking system, comprising the steps of:
a. activating said electronic equipment,
b. selecting activation of said locking system,
c. entering a user code,
d. selecting at least one programmable feature,
e. selecting a programmable feature activation time period,
f. saving said programmable feature and said programmable feature activation time period in said locking system memory.

11. The method of claim 10 further comprising the step of repeating steps c-f until all intended programmable features are selected.

12. The method of claim 10 further comprising the step of selecting the programmable feature enabling timed operation.

13. The method of claim 12 further comprising the step of electing to set said timed operation by clock setting.

14. The method of claim 12 further comprising the step of electing said timed operation by the number of minutes of operation from the time of entering the programming.

15. The method of claim 10 further comprising the step of selecting the programmable feature enabling sleep mode.

16. The method of claim 15 further comprising the step of programming a start time and an end time to said sleep mode.

17. The method of claim 10 further comprising the step of selecting the programmable feature enabling a delayed start mode.

18. The method of claim 17 further comprising the step of programming a start time and an end time to said delayed start mode.

19. The method of claim 10 further comprising the step of selecting the programmable feature enabling a partial operation mode.

20. The method of claim 19 further comprising the step of electing to permit outgoing calls and block incoming calls for a predetermined, programmable, time period.

21. The method of claim 19 further comprising the step of electing to permit incoming calls and block outgoing calls for a predetermined, programmable, time period.

22. An operating control device for equipment having an exterior case, a power source, an internal feature activation member, said control device having:
a predetermined user access code,
a programmable feature selection member, said programmable feature selection member enables at least one programmable feature to be selected by said user, said programmable features include at least one from the list of
normal operation,
timed operation, said timed operation operating said equipment for a predetermined period of time set by a user;
sleep mode, said sleep mode preventing operation of said equipment for a user selected period of time, returning to operation at the expiration of said user selected period of time;
delayed start, said delayed start preventing operation until a user sent time;
partial operation, said partial operation enabling a user to selection one or more functions of said equipment for operation and selecting one or more functions of said equipment for non operation,
at least one programmable feature activation time period, said programmable feature activation time period being set by a user for each of said at least one programmable feature,
an input device, said input device permitting input of said predetermined user access code, said programmable feature selection and said programmable feature activation time period;
a readout panel, said readout panel providing a status of said operating control device;
an internal control member, said control member being in direct communication with said input device, said power source, said programmable feature activation time period and said programmable feature activation member,
wherein said internal control member controls operation of said equipment by controlling power transfer from said power source to one or more said programmable features based upon user selection of said programmable feature and said programmable feature activation time.
